(19) United States
(12) Patent Application Publication
(10) Pub. No.: US 2025/0106879 A1
(43) Pub. Date: Mar. 27, 2025

(54) INFORMATION PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Qin MU, Beijing (CN); Juan ZHANG, Beijing (CN)

(21) Appl. No.: 18/728,978

(22) PCT Filed: Jan. 20, 2022
(86) PCT No.: PCT/CN2022/073057

§ 371 Date: Jul. 15, 2024

(51) Int. Cl. H04W 72/51; H04L 5/14; H04W 72/0457

(52) U.S. Cl. CPC H04W 72/51; H04L 5/1438; H04W 72/0457

(57) ABSTRACT

A method for processing information is performed by a terminal, and includes: determining whether simultaneous downlink reception and uplink transmission are supported by the terminal; and determining a Frequency Division Duplex (FDD) mode in which the terminal operates according to a result of determining whether the simultaneous downlink reception and uplink transmission are supported by the terminal.

### CROSS-REFERENCE

The present application is a U.S. National Stage of International Application No. PCT/CN2022/073057, filed on Jan. 20, 2022, the content of which is incorporated herein by reference in its entirety.

### TECHNICAL FIELD

The present disclosure relates to, but is not limited to, the field of wireless communication technologies, and in particular to a method and apparatus for processing information, a communication device and a storage medium.

### BACKGROUND

With the development of technologies, a variety of terminals supporting different bandwidths have emerged. For example, in Long Term Evolution (LTE) 4th Generation (4G) mobile communication systems, in order to support Internet of Things (IoT) services, two major technologies, Machine Type Communication (MTC) and Narrow Band Internet of Things (NB-IoT), are proposed. These two technologies are mainly aimed at low-rate and high-latency scenarios, such as meter reading and/or environmental monitoring.

### SUMMARY

Embodiments of the present disclosure provide a method and apparatus for processing information, a communication device, and a storage medium.

A first aspect of embodiments of the present disclosure provides a method for processing information, which is performed by a terminal, and the method includes:
determining whether simultaneous downlink reception and uplink transmission are supported by the terminal; and
determining a Frequency Division Duplex (FDD) mode in which the terminal operates according to a result of determining whether the simultaneous downlink reception and uplink transmission are supported by the terminal.

A second aspect of embodiments of the present disclosure provides a method for processing information, which is performed by a network device, and the method includes:
determining whether simultaneous downlink reception and uplink transmission are supported by a terminal; and
determining a Frequency Division Duplex (FDD) mode in which the terminal operates according to a result of determining whether the simultaneous downlink reception and uplink transmission are supported by the terminal.

A third aspect of embodiments of the present disclosure provides a communication device, including a processor, a transceiver, a memory, and an executable program stored in the memory and capable of being run by the processor, wherein the processor performs the method for processing the information provided in the first aspect or the second aspect when running the executable program.

A fourth aspect of embodiments of the present disclosure provides a computer storage medium having an executable program stored thereon, wherein the executable program, when performed by a processor, is capable of implementing the method for processing the information provided in the first aspect or the second aspect.

It should be noted that the above general description and the following detailed description are merely exemplary and explanatory and should not be construed as limiting of embodiments of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain principles of embodiments of the present disclosure.

FIG. 1 shows a schematic structural diagram of a wireless communication system according to an embodiment of the present disclosure;

FIG. 2 shows a schematic flowchart of a method for processing information according to an embodiment of the present disclosure;

FIG. 3 shows a schematic flowchart of a method for processing information according to an embodiment of the present disclosure;

FIG. 4 shows a schematic flowchart of a method for processing information according to an embodiment of the present disclosure;

FIG. 5 shows a schematic diagram of monitored UL BWP and DL BWP meeting a separation condition according to an embodiment of the present disclosure;

FIG. 6 shows a schematic flowchart of a method for processing information according to an embodiment of the present disclosure;

FIG. 7 shows a schematic diagram of monitored UL BWP and DL BWP meeting a separation condition according to an embodiment of the present disclosure;

FIG. 8 shows a schematic flowchart of a method for processing information according to an embodiment of the present disclosure;

FIG. 9 shows a schematic diagram of monitored UL BWP and DL BWP meeting a separation condition according to an embodiment of the present disclosure;

FIG. 10 shows a schematic flowchart of a method for processing information according to an embodiment of the present disclosure;

FIG. 11 shows a schematic flowchart of a method for processing information according to an embodiment of the present disclosure;

FIG. 12 shows a schematic flowchart of a method for processing information according to an embodiment of the present disclosure;

FIG. 13 shows a schematic flowchart of a method for processing information according to an embodiment of the present disclosure;

FIG. 14 shows a schematic flowchart of a method for processing information according to an embodiment of the present disclosure;

FIG. 15 shows a schematic structural diagram of an apparatus for processing information according to an embodiment of the present disclosure;

FIG. 16 shows a schematic flowchart of a method for processing information according to an embodiment of the present disclosure;

FIG. 17 shows a schematic structural diagram of a terminal according to an embodiment of the present disclosure; and

FIG. 18 shows a schematic structural diagram of a communication device according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of the embodiments of the present disclosure as recited in the appended claims.

The terms used in the embodiments of the present disclosure are merely for the purpose of describing particular embodiments and are not intended to limit the embodiments of the present disclosure. As used in the embodiments of the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of embodiments of the present disclosure, first information may also be referred to as second information, and similarly, the second information may also be referred to as the first information. Depending on the context, the word “if” as used herein can be interpreted as “upon” or “when” or “in response to determination”.

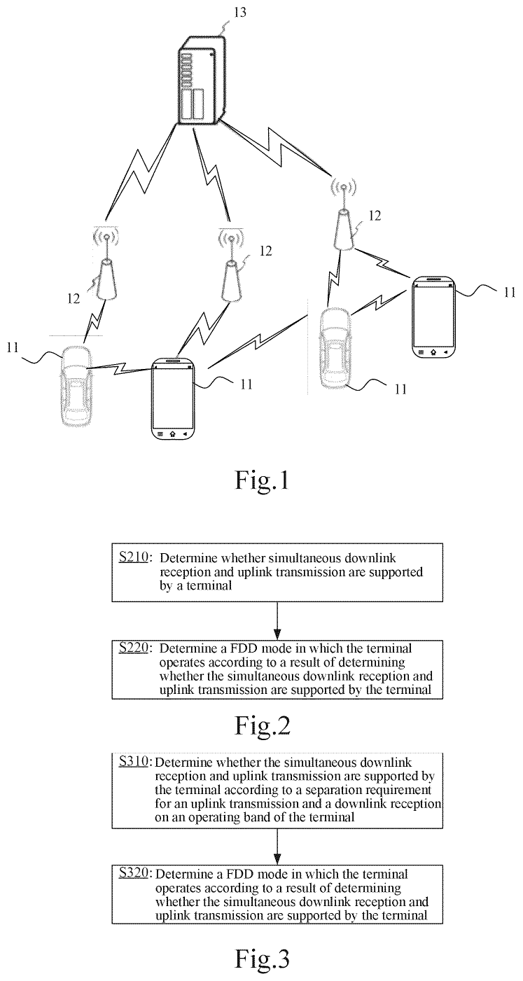

Reference is made to FIG. 1, which shows a schematic structural diagram of a wireless communication system provided by an embodiment of the present disclosure. As illustrated in FIG. 1, the wireless communication system is a communication system based on cellar mobile communication technologies. The wireless communication system may include several UEs 11 and several access devices 12.

The UE 11 may refer to a device that provides voice and/or data connectivity to a user. The UE 11 may communicate with one or more core networks via a Radio Access Network (RAN). The UE 11 may be an Internet of Things UE, such as a sensor device, a mobile phone (or called “cellular” phone) and a computer with the Internet of Things UE, for example, may be a fixed, portable, pocket-sized, handheld, built-in computer or vehicle-mounted device. For example, the UE may be a station (STA), a subscriber unit, a subscriber station, a mobile station, a mobile, a remote station, an access point, a remote terminal, an access terminal, a user terminal, a user agent, a user device, or user equipment. Or, the UE 11 may also be a device of an unmanned aerial vehicle. Or, the UE 11 may also be a vehicle-mounted device, such as a trip computer with a wireless communication function, or a wireless communication device connected to an external trip computer. Or, the UE 11 may also be a roadside device, such as a streetlight, a signal light or another roadside device with a wireless communication function.

The access device 12 can be a network-side device in a wireless communication system. The wireless communication system can be a 4th generation mobile communication (4G) system, also known as a Long Term Evolution (LTE) system. Or, the wireless communication system may also be a 5G system, also known as a New Radio (NR) system or a 5G NR system. Or, the wireless communication system may also be a next-generation system of 5G system or a MTC system. An access network in the 5G system can be referred to as a New Generation-Radio Access Network (NG-RAN).

The access device 12 can be an evolved NodeB (eNB) in the 4G system. Or, the access device 12 may also be a gNB with a central distributed architecture in the 5G system. When the access device 12 adopts the central distributed architecture, it usually includes a Central Unit (CU) and at least two Distributed Units (DUs). The CU is provided with a protocol stack of a Packet Data Convergence Protocol (PDCP) layer, a Radio Link Control (RLC) layer, and a Media Access Control (MAC) layer. The DU is provided with a protocol stack of a Physical (PHY) layer. A specific implementation of the access device 12 is not limited in embodiments of the present disclosure.

A wireless connection can be established between the access device 12 and the UE 11 through a radio air interface. In different implementations, the radio air interface is a radio air interface based on a 4th generation mobile communication network technology (4G) standard. Or, the radio air interface is a radio air interface based on a 5th generation mobile communication network technology (5G) standard, such as the NR. Or, the radio air interface may also be a radio air interface based on a 5G next-generation mobile communication network technology standard.

In some embodiments, an End to End (E2E) connection may also be established between UEs 11, such as a vehicle to vehicle (V2V) communication, a vehicle to infrastructure (V2I) communication and a vehicle to pedestrian (V2P) communication in a vehicle to everything (V2X) communication, and other scenarios.

In some embodiments, the above wireless communication system may further include a network management device 13.

The several access devices 12 are connected to the network management device 13, respectively. The network management device 13 can be a core network device in the wireless communication system. For example, the network management device 13 can be a Mobility Management Entity (MME) in an Evolved Packet Core (EPC) network. Or, the network management device may also be another core network device, such as a Serving Gateway (SGW), a Public Data Network Gateway (PGW), a Policy and Charging Rules Function (PCRF) unit or a Home Subscriber Server (HSS). An implementation form of the network management device 13 is not limited in embodiments of the present disclosure.

As described above, with the development of technologies, a variety of terminals supporting different bandwidths have emerged. For example, in Long Term Evolution (LTE) 4th Generation (4G) mobile communication systems, in order to support Internet of Things (IoT) services, two major technologies, Machine Type Communication (MTC) and Narrow Band Internet of Things (NB-IoT), are proposed. These two technologies are mainly aimed at low-rate and high-latency scenarios, such as meter reading and/or environmental monitoring.

At present, NB-IoT only supports a maximum rate of several hundred kilobits, and MTC only supports a maximum rate of several megabits. But on the other hand, with the continuous development of the IoT services, such as the popularization of video surveillance, smart home, wearable devices, industrial sensing monitoring and the like, these services typically require a rate of tens to 100 M, and also have relatively high requirements for latency. Accordingly, it is difficult for MTC and NB-IoT technologies in LTE to meet the requirements. In view of this situation, a new user equipment is provided in the 5G new radio to cover the requirements of midrange IoT devices. This new type of terminal is called a Reduced Capability User Equipment (RedCap UE) or a NR-lite terminal for short.

A bandwidth supported by the RedCap UE or the RedCap terminal is smaller than a bandwidth supported by a normal terminal.

As shown in FIG. 2, embodiments of the present disclosure provide a method for processing information, which is performed by a terminal. The method includes:

in S210, it is determined whether the terminal supports simultaneous downlink reception and uplink transmission; and

in S220, an FDD mode in which the terminal operates is determined according to a result of determining whether the terminal supports the simultaneous downlink reception and uplink transmission.

The terminal may be any terminal. Further, the terminal may be a terminal other than a normal terminal. For example, the terminal may be a RedCap terminal. A bandwidth supported by the RedCap terminal is smaller than a bandwidth supported by the normal terminal. The bandwidth supported by the normal terminal may be equal to a system bandwidth of a communication system. That is, in some embodiments, the bandwidth supported by the terminal may be smaller than the system bandwidth.

The maximum bandwidth supported by the normal terminal under FR1 can be up to 100 MHz, and the maximum bandwidth supported by the normal terminal under FR2 can be up to 400 MHz.

The terminal will determine whether it supports the simultaneous downlink reception and uplink transmission according to the determination method. If it is determined that the terminal can simultaneously perform the uplink transmission and the downlink reception, the FDD mode used by the terminal can be flexibly configured according to the determination result. The determination method may be pre-negotiated by the terminal and a network device, or agreed upon according to a protocol.

For example, S210 may include: determining whether the terminal currently supports the simultaneous downlink reception and uplink transmission according to one or more of the maximum bandwidth supported by the terminal, a current operating band of the terminal, and a UL BWP and a DL BWP currently monitored by the terminal.

The simultaneous downlink reception and uplink transmission here mean that the terminal can perform the downlink reception and the uplink transmission at the same time, and such downlink reception and uplink transmission do not interfere with each other. That is, the uplink transmission and the downlink reception performed simultaneously need to meet various separation requirements such as communication standards to ensure the communication quality of the uplink transmission and the downlink reception.

The FDD mode may be at least divided into a full-duplex FDD mode and a half-duplex FDD mode.

If the terminal operates in the full-duplex FDD mode, the terminal can simultaneously perform the uplink transmission and the downlink reception at the same time domain position. If the terminal operates in the half-duplex FDD mode, the terminal can only perform the uplink transmission or the downlink reception at one time point.

That is, S220 may include: determining whether the terminal operates in the full-duplex FDD mode or the half-duplex FDD mode according to whether the terminal supports the simultaneous uplink transmission and downlink reception.

As shown in FIG. 3, embodiments of the present disclosure provide a method for processing information, which is performed by a terminal. The method includes:

in S310, it is determined whether the terminal supports simultaneous downlink reception and uplink transmission according to a separation requirement for an uplink transmission and a downlink reception on an operating band of the terminal; and

in S320, an FDD mode in which the terminal operates is determined according to a result of determining whether the terminal supports the simultaneous downlink reception and uplink transmission.

The terminal may be any terminal. Further, the terminal may be a terminal other than a normal terminal. For example, the terminal may be a RedCap terminal. A bandwidth supported by the RedCap terminal is smaller than a bandwidth supported by the normal terminal. The bandwidth supported by the normal terminal may be equal to a system bandwidth of a communication system. That is, in some embodiments, the bandwidth supported by the terminal may be smaller than the system bandwidth.

There are a plurality of operating bands for the terminal, and separation requirements for uplink transmission and downlink reception in different operating bands are different.

Referring to Table 1, separation requirements for uplink transmission and downlink reception corresponding to different operating bands are exemplified.

TABLE 1

| | | Tx-Rx Separation | |
|---|---|---|---|
| Serial number | NR band | requirement | |
| 1 | N1 | 190 | MHz |
| 2 | N2 | 80 | MHz |
| 3 | N3 | 95 | MHz |
| 4 | N5 | 45 | MHz |
| 5 | N7 | 120 | MHz |
| 6 | N8 | 45 | MHz |
| 7 | N12 | 30 | MHz |
| 8 | N13 | −31 | MHz |
| 9 | N14 | −30 | MHz |
| 10 | N18 | 45 | MHz |
| 11 | N20 | −41 | MHz |
| 12 | N24 | −101.5, −120.5 | MHz |
| 13 | N25 | 80 | MHz |
| 14 | N26 | 45 | MHz |
| 15 | N28 | 55 | MHz |
| 16 | N30 | 45 | MHz |
| 17 | N65 | 190 | MHz |
| 18 | N66 | 400 | MHz |
| 19 | N70 | 300 | MHz |
| 20 | N71 | −46 | MHz |
| 21 | N74 | 48 | MHz |
| 22 | N85 | 30 | MHz |

| | | |
|---|---|---|
| 23 | N91 | 570-595 MHz ( |
| 24 | N92 | 575-680 MHz (u = 0) |
| | | 580-675 MHz (u = 1) |
| 25 | N93 | 517 MHz-632 MHz (u = 0) |
| | | 527 MHz-627 MHz (u = 1) |
| 26 | N94 | 517 MHz-632 MHz (u = 0) |
| | | 527 MHz-627 MHz (u = 1) |

It should be noted that one or more elements in Table 1 can be used alone or in combination, and Table 1 shows examples of the Tx-Rx separation requirement and the operating band of the terminal, and a specific implementation is not limited to the above examples.

The Tx-Rx separation requirement refers to the separation requirement for the uplink transmission and the downlink reception.

In S310, it is determined whether uplink and downlink BWPs monitored by the terminal meet a separation requirement for the uplink transmission and the downlink reception on the operating band. If the separation requirement is met, the terminal performs the uplink transmission and the downlink reception at the same time, which enables the terminal to operate in the full-duplex FDD mode, otherwise the terminal can operate in the half-duplex FDD mode. The uplink and downlink BWPs include: a UL BWP and a DL BWP.

In addition, even though the uplink and downlink BWPs monitored by the terminal on the operating band meet the separation requirement, the network device on the network side (for example, the base station) can still indicate or suggest the terminal to operate in the half-duplex FDD mode according to a network capacity, a service requirement and the like, thereby realizing the flexible scheduling of the full-duplex mode and the half-duplex FDD mode of the terminal according to the communication requirement, and realizing the flexible switching of the operating BWP of the terminal if the terminal capability supports it.

In some embodiments, S310 may specifically include:

determining whether the terminal supports the simultaneous downlink reception and uplink transmission according to an UL BWP and a DL BWP monitored by the terminal on the operating band and the separation requirement for the uplink transmission and the downlink reception.

One operating band may be configured with a plurality of BWPs. Different BWPs may be configured with different reference signals or different information contents carried by the same reference signal. The terminal may determine the BWP it is currently monitoring through the configuration by the network. If the terminal can successfully monitor a certain BWP, this BWP may be used as an operating BWP of the terminal or may be called an active BWP. The terminal may perform the uplink transmission and the downlink reception on the active BWP. It is understood that the UL/DL BWPs monitored by the terminal on the operating band in various embodiments of the present disclosure may all be active BWPs.

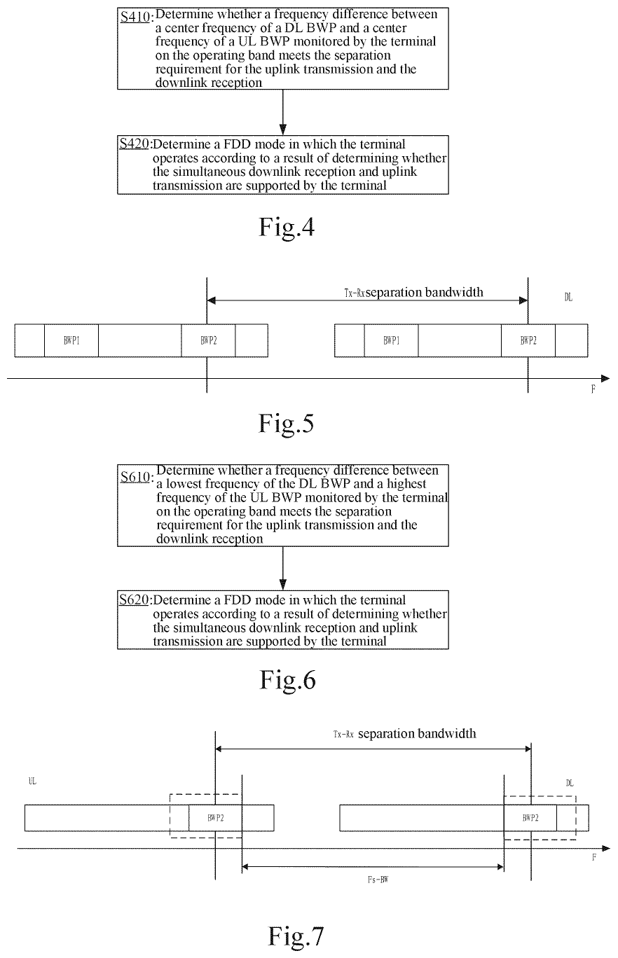

As shown in FIG. 4, embodiments of the present disclosure provide a method for processing information, which is performed by a terminal. The method includes:

in S410, it is determined whether a frequency difference between a center frequency of the DL BWP and a center frequency of the UL BWP monitored by the terminal on the operating band meets the separation requirement for the uplink transmission and the downlink reception; and

in S420, a FDD mode in which the terminal operates is determined according to a result of determining whether the terminal supports the simultaneous downlink reception and uplink transmission.

The terminal may be any terminal. Further, the terminal may be a terminal other than a normal terminal. For example, the terminal may be a RedCap terminal. A bandwidth supported by the RedCap terminal is smaller than a bandwidth supported by the normal terminal. The bandwidth supported by the normal terminal may be equal to a system bandwidth of a communication system. That is, in some embodiments, the bandwidth supported by the terminal may be smaller than the system bandwidth.

Referring to FIG. 5, in embodiments of the present disclosure, if the terminal monitors that a UL BWP of the system bandwidth on its operating band is UL BWP2, and also detects that a DL BWP of the system bandwidth is DL BWP2, it is determined whether the frequency difference between the center frequency of UL BWP2 and the center frequency of DL BWP2 meets the separation requirement for the uplink transmission and the downlink reception.

In FIG. 5, the horizontal axis represents the frequency (F), and a direction of the arrow on the horizontal axis is a direction in which a frequency value increases. FIG. 5 shows a UL system bandwidth and a DL system bandwidth. The UL system bandwidth is used for the uplink transmission of the terminal, and the DL system bandwidth is used for the downlink reception of the terminal.

One or more DL BWPs are configured on the DL system bandwidth, and one or more UL BWPs are configured on the UL system bandwidth. The plurality of BWPs on the DL system bandwidth may be numbered and sorted sequentially, and the plurality of BWPs on the UL system bandwidth may be numbered and sorted sequentially.

For example, with reference to Table 1, it is assumed that the current operating band of the terminal is N3 and the terminal detects UL BWP1 and DL BWP1 at the same time, the terminal will calculate a difference between center frequencys of UL BWP1 and DL BWP1. If the difference is less than 95 MHz, it means that the terminal currently does not support the simultaneous downlink reception and uplink transmission. If the difference is greater than or equal to 95 MHz, it means that the terminal currently supports the simultaneous downlink reception and uplink transmission.

For another example, with reference to Table 1, it is assumed that the current operating band of the terminal is N7, and the terminal detects UL BWP2 and DL BWP1 at the same time, and calculates that a difference between the center frequency of UL BWP2 and the center frequency of DL BWP1 is less than 120 MHz, it can be considered that if the terminal performs the uplink transmission on UL BWP2 and performs downlink reception on DL BWP1, the uplink transmission and the downlink reception will interfere with each other, that is, the separation requirement for the uplink transmission and the downlink reception is not met, and it can be considered that the terminal currently does not support the simultaneous uplink transmission and downlink reception.

As shown in FIG. 6, embodiments of the present disclosure provide a method for processing information, which is performed by a terminal. The method includes:

in S610, it is determined whether a frequency difference between a lowest frequency of the DL BWP and a highest frequency of the UL BWP monitored by the terminal on the operating band meets the separation requirement for the uplink transmission and the downlink reception; and

in S620, an FDD mode in which the terminal operates is determined according to a result of determining whether the terminal supports the simultaneous downlink reception and uplink transmission.

The terminal may be any terminal. Further, the terminal may be a terminal other than a normal terminal. For example, the terminal may be a RedCap terminal. A bandwidth supported by the RedCap terminal is smaller than a bandwidth supported by the normal terminal. The bandwidth supported by the normal terminal may be equal to a system bandwidth of a communication system. That is, in some embodiments, the bandwidth supported by the terminal may be smaller than the system bandwidth.

The terminal may be configured with a channel bandwidth (BW), which is generally greater than a bandwidth of one BWP. An upper boundary value of the channel bandwidth may just coincide with a boundary of the monitored BWP, or the upper boundary value of the channel bandwidth may not overlap with a boundary value of any monitored BWP; and/or, similarly, a lower boundary value of the channel bandwidth may just coincide with a boundary of the monitored BWP, or the lower boundary value of the channel bandwidth may not overlap with the boundary value of any monitored BWP.

As shown in FIG. 7, the terminal simultaneously monitors UL BWP2 of the UL system bandwidth and DL BWP2 of the DL system bandwidth on its operating band, determines the lowest frequency of DL BWP2 and the highest frequency of UL BWP2, and then makes a difference between the lowest frequency of DL BWP2 and the highest frequency of UL BWP2 to obtain the frequency difference mentioned in this embodiment. Based on the frequency difference, it is determined whether the separation requirement for the uplink transmission and the downlink reception is met.

For example, determining whether the frequency difference between the lowest frequency of the DL BWP and the highest frequency of the UL BWP monitored by the terminal on the operating band meets the separation requirement for the uplink transmission and the downlink reception includes:

determining whether the frequency difference between the lowest frequency of the DL BWP and the highest frequency of the UL BWP detected by the terminal meets a separation requirement of a first threshold.

For example, for a case where an uplink channel bandwidth of the terminal is equal to a downlink channel bandwidth of the terminal, the first threshold may be equal to Fs-BW, where Fs may be a separation bandwidth value of the uplink transmission and the downlink reception on the operating band of the terminal, and BW may be an uplink channel bandwidth or a downlink channel bandwidth supported by the terminal.

For another example, for a case where the uplink channel bandwidth of the terminal is not equal to the downlink channel bandwidth of the terminal, the first threshold may be equal to Fs−0.5*uplink channel bandwidth−0.5*downlink channel bandwidth.

This is just an example of the first threshold, and a specific implementation is not limited to this example.

Here, determining whether the frequency difference between the lowest frequency of the DL BWP and the highest frequency of the UL BWP detected by the terminal meets the separation requirement of the first threshold may at least include:
the frequency difference between the lowest frequency of the DL BWP and the highest frequency of the UL BWP detected by the terminal is greater than the first threshold.

In embodiments of the present disclosure, if the frequency difference between the lowest frequency of the DL BWP and the highest frequency of the UL BWP detected by the terminal is greater than the first threshold, it can be considered that the terminal currently supports the simultaneous uplink transmission and downlink reception; otherwise, it can be considered that the terminal currently does not support the simultaneous uplink transmission and downlink reception.

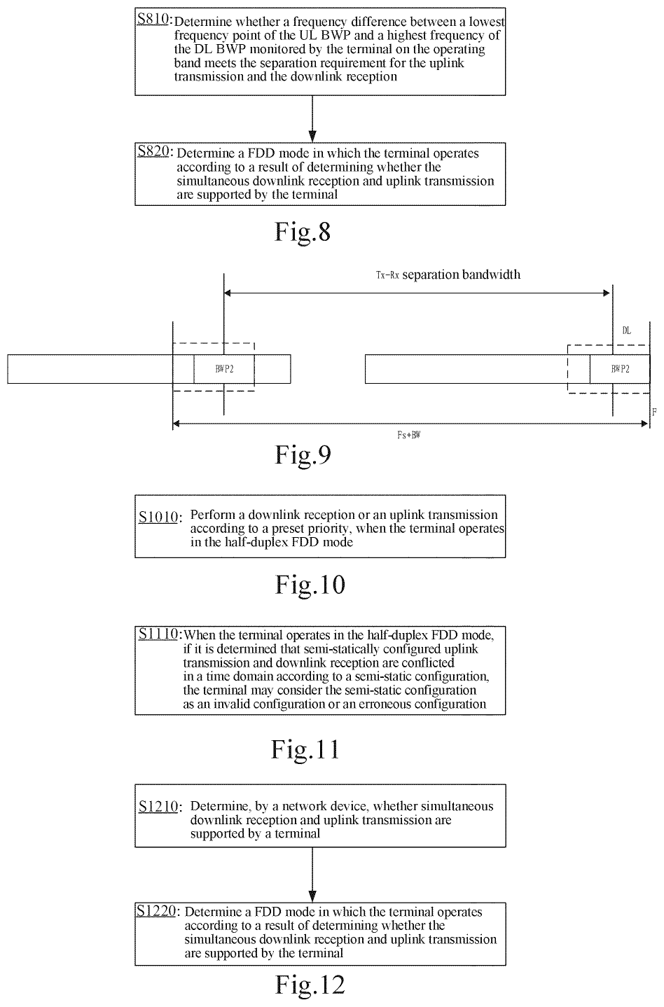

As shown in FIG. 8, embodiments of the present disclosure provide a method for processing information, which is performed by a terminal. The method includes:
in S810, it is determined whether a frequency difference between a lowest frequency of the UL BWP and a highest frequency of the DL BWP monitored by the terminal on the operating band meets the separation requirement for the uplink transmission and the downlink reception; and
in S820, an FDD mode in which the terminal operates is determined according to a result of determining whether the terminal supports the simultaneous downlink reception and uplink transmission.

The terminal may be any terminal. Further, the terminal may be a terminal other than a normal terminal. For example, the terminal may be a RedCap terminal. A bandwidth supported by the RedCap terminal is smaller than a bandwidth supported by the normal terminal. The bandwidth supported by the normal terminal may be equal to a system bandwidth of a communication system. That is, in some embodiments, the bandwidth supported by the terminal may be smaller than the system bandwidth.

As shown in FIG. 9, it is assumed that if the terminal monitors that the UL BWP of the system bandwidth on its operating band is UL BWP2 and also detects that the DL BWP of the system bandwidth is DL BWP2, the terminal will determine the lowest frequency of UL BWP2 and the highest frequency of DL BWP2, and calculate the frequency difference between the determined lowest frequency of UL BWP2 and highest frequency of DL BWP2 to determine whether the separation requirement for the uplink transmission and the downlink reception of the terminal on the current operating band is met.

For example, S810 may include: determining whether the frequency difference between the lowest frequency of the UL BWP and the highest frequency of the DL BWP monitored by the terminal meets a separation requirement of a second threshold.

When the uplink channel bandwidth supported by the terminal is equal to the downlink channel bandwidth supported by the terminal, the second threshold may be equal to Fs+BW, where Fs may be a separation bandwidth value of the uplink transmission and the downlink reception on the operating band of the terminal, and BW may be an uplink channel bandwidth or a downlink channel bandwidth supported by the terminal.

When the uplink channel bandwidth supported by the terminal is not equal to the downlink channel bandwidth supported by the terminal, the second threshold may be equal to Fs+0.5*uplink channel bandwidth+0.5*downlink channel bandwidth.

It should be noted that the above is merely an example of the second threshold, and the specific implementation is not limited to the above example.

Here, determining whether the frequency difference between the lowest frequency of the UL BWP and the highest frequency of the DL BWP monitored by the terminal meets the separation requirement of the second threshold may at least include:
determining whether the frequency difference between the lowest frequency of the UL BWP and the highest frequency of the DL BWP monitored by the terminal is less than the second threshold.

In embodiments of the present disclosure, if the frequency difference between the highest frequency of the DL BWP and the lowest frequency of the UL BWP detected by the terminal is less than the second threshold, it can be considered that: the terminal currently supports the simultaneous uplink transmission and downlink reception; otherwise, it can be considered that the terminal currently does not support the simultaneous uplink transmission and downlink reception.

In some embodiments, determining whether the terminal supports the simultaneous uplink transmission and downlink reception may include:
determining whether the frequency difference between the lowest frequency of the DL BWP and the highest frequency of the UL BWP monitored by the terminal on the operating band meets the separation requirement for the uplink transmission and the downlink reception, and determining whether the frequency difference between the lowest frequency of the UL BWP and the highest frequency of the DL BWP monitored by the terminal on the operating band meets the separation requirement for the uplink transmission and the downlink reception. For example, the frequency difference between the center frequency of the DL BWP and the center frequency of the UL BWP monitored by the terminal on the operating band meets the separation requirement of the first threshold, and it is determined that the frequency difference between the lowest frequency of the UL BWP and the highest frequency of the DL BWP monitored by the terminal meets the separation requirement of the second threshold, it can be determined that the terminal supports the simultaneous uplink transmission and downlink reception, otherwise it can be considered that the terminal does not support the simultaneous uplink transmission and downlink reception.

In some embodiments, determining the Frequency Division Duplex (FDD) mode in which the terminal operates according to the result of determining whether the terminal supports the simultaneous downlink reception and uplink transmission includes:
when the terminal supports the simultaneous downlink reception and uplink transmission, determining that the terminal operates in a full-duplex FDD mode; and
when the terminal does not support the simultaneous downlink reception and uplink transmission, determining that the terminal operates in a half-duplex FDD mode.

The terminal operating in the full-duplex FDD mode will simultaneously enable a radio frequency path corresponding to the UL BWP and a radio frequency path corresponding to the DL BWP, so as to perform the uplink transmission and the downlink reception at the same time domain position, respectively.

The terminal operating in the half-duplex FDD mode only operates in the UL BWP or the DL BWP at a time. In this way, when the terminal operates on the DL BWP, if it needs to perform the uplink transmission, the terminal needs to switch to the UL BWP through the uplink and downlink switching before performing the uplink transmission. When the terminal operates on the UL BWP, if it needs to perform the downlink reception, the terminal needs to switch to the DL BWP through the uplink and downlink switching before performing the downlink reception.

Alternatively, in some embodiments, considering the power consumption of the terminal and the service characteristic of the terminal, for example, some terminals actually have substantively more uplink transmission demands than downlink reception demands, or have substantively more downlink reception demands than uplink transmission demands, and in this case, even if the terminal supports the simultaneous downlink reception and uplink transmission, the terminal can still choose to operate in the half-duplex FDD mode according to its own service requirements. Further, if the terminal operates in the half-duplex FDD mode, it will further prefer to operate on the UL BWP or the DL BWP with the large service demand in the half-duplex FDD mode according to the service characteristic or the service requirement of the terminal, so as to reduce the number of uplink and downlink switching of the terminal in the half-duplex FDD mode.

As shown in FIG. 10, embodiments of the present disclosure provide a method for processing information, which is performed by a terminal. The method includes:
in S1010, when the terminal operates in the half-duplex FDD mode, the terminal performs the downlink reception or the uplink transmission according to a preset priority.

The method for processing the information provided in this embodiment can be performed alone, or in combination with the aforementioned method for processing the information performed by any terminal.

For example, for the method for determining that the terminal operates in the half-duplex FDD mode, the method for processing the information provided in the above embodiments may be used for determination, or other methods may be used for determination. For example, the terminal can determine to operate in the half-duplex FDD mode according to a user configuration or a default configuration of the terminal.

The terminal may be a normal terminal and/or the aforementioned RedCap terminal.

When the terminal operates in the half-duplex FDD mode, it may be inevitable that the downlink reception and the uplink transmission at a certain time point or certain time points may conflict with each other. In order to resolve this conflict, the preset priority is introduced.

For example, priorities are pre-configured for various uplink transmissions and downlink receptions by the base station, the protocol agreement or the like. When the terminal monitors a conflict, it will prioritize a transmission with a preset high priority and abandon a transmission with a low priority, thereby reducing the phenomenon that the terminal operating in the half-duplex FDD mode cannot well coordinate the transmission when there is both the UL transmission and the DL transmission at the same time domain position, thereby ensuring the communication quality of the terminal.

In some embodiments, performing the downlink reception or the uplink transmission according to the preset priority when the terminal operates in the half-duplex FDD mode includes at least one of:
performing reception of a Synchronization Signal Block (SSB) according to the preset priority, when an uplink transmission of the terminal is in conflict with downlink reception of the SSB of the terminal;
performing a dynamically scheduled uplink transmission according to the preset priority, when the dynamically scheduled uplink transmission of the terminal is in conflict with a semi-statically configured downlink reception of the terminal; or
performing a dynamically scheduled downlink reception according to the preset priority, when the dynamically scheduled downlink reception of the terminal is in conflict with a semi-statically configured uplink transmission of the terminal.

For example, the terminal prioritizes the reception of the SSB, which can realize the measurement of the current cell and/or the neighbor cell, thereby facilitating the terminal to switch or reselect to a more suitable cell in time before and after movement and/or when the cell communication quality fluctuates, thereby ensuring the communication quality of the terminal. The uplink transmission of the terminal can be performed after the completion of the downlink reception of the SSB.

For example, the network device may perform the semi-static configuration through a semi-static instruction. The semi-static instruction includes but is not limited to an RRC instruction. The semi-static instruction means that one or more transmissions are configured according to a semi-static cycle within a semi-static configuration time range. The terminal will perform the corresponding transmission according to the semi-static configuration when the corresponding semi-static cycle is reached.

For example, for the call or the information transmission of a peer device, the network device may dynamically schedule the transmission of the terminal. For example, the uplink transmission and/or the downlink reception of the terminal are dynamically scheduled using DCI. As a result, the dynamically scheduled uplink transmission may conflict with the semi-statically configured downlink reception. In view of this, considering that the dynamic scheduling may be an emergency scheduling, and the semi-static configuration may be transmitted in the next semi-static cycle, the dynamically scheduled uplink transmission will be prioritized according to the preset priority.

Alternatively, if the semi-statically configured uplink transmission conflicts with the dynamically scheduled downlink reception, considering that the dynamically scheduling is typically related to the emergency service, the dynamically scheduled downlink reception may also be given priority and the semi-statically configured uplink transmission may be temporarily suspended.

The semi-statically configured uplink transmission and/or downlink reception currently suspended may be completed in one or more subsequent semi-static cycles.

As shown in FIG. 11, embodiments of the present disclosure provide a method for processing information, which is performed by a terminal. The method includes:
in S1110, when the terminal operates in a half-duplex FDD mode, if it is determined that semi-statically configured uplink transmission and downlink reception are conflicted in a time domain according to a semi-static configuration, the terminal may consider the semi-static configuration as an invalid configuration or an erroneous configuration.

If the terminal detects the invalid configuration or the erroneous configuration, the terminal may ignore the corresponding semi-static configuration, or report a notification of the invalid configuration or the erroneous configuration to the network device (e.g., the base station).

The method for processing the information provided in this embodiment can be performed alone, or in combination with the aforementioned method for processing the information performed by any terminal.

For example, for the method for determining that the terminal operates in the half-duplex FDD mode, the method for processing the information provided in the above embodiments may be used for determination, or other methods may be used for determination. For example, the terminal can determine to operate in the half-duplex FDD mode according to a user configuration or a default configuration of the terminal.

As another example, the method for processing the information may also be combined with the aforementioned method of using the preset priority to resolve two or more transmissions at the same time domain position, and the method for processing the information shown in FIG. 10 may be adopted.

The terminal may be the normal terminal and/or the aforementioned RedCap terminal.

As shown in FIG. 12, embodiments of the present disclosure provide a method for processing information, which is performed by a network device. The method includes:
in S1210, the network device determines whether a terminal supports simultaneous downlink reception and uplink transmission; and
in S1220, an FDD mode in which the terminal operates is determined according to a result of determining whether the terminal supports the simultaneous downlink reception and uplink transmission.

The network device may be any access network device, and for example, the access network device may be a base station, which may be a gNB or an eNB.

The network device will determine whether it supports the simultaneous downlink reception and uplink transmission according to the determination method. If it is determined that the terminal can simultaneously perform the uplink transmission and the downlink reception, the FDD mode used by the terminal can be flexibly configured according to the determination result. The determination method may be pre-negotiated by the terminal and a network device, or agreed upon according to a protocol.

Finally, the network device will determine the FDD mode in which the terminal operates based on whether the terminal supports the simultaneous downlink reception and uplink transmission.

Furthermore, after the network device determines the FDD mode in which the terminal operates, it performs the resource scheduling and/or the transmission scheduling for the terminal according to the FDD mode in which the terminal operates, so as to achieve orderly uplink and downlink scheduling and transceiving while taking into account the bandwidth supported by the terminal.

In some embodiments, S1210 may include: determining whether the terminal supports simultaneous downlink reception and uplink transmission according to a separation requirement for an uplink transmission and a downlink reception on an operating band of the terminal.

The wireless communication may be configured with a plurality of bands, and different bands can have different separation requirements for uplink transmission and downlink reception. For example, the separation requirements of different operating bands can be shown in Table 1, but the specific implementation is not limited to that shown in Table 1.

In this way, according to the separation requirement of the operating band of the terminal, it can be determined whether the terminal supports the simultaneous downlink reception and uplink transmission on the current operating band.

In some embodiments, determining whether the terminal supports the simultaneous downlink reception and uplink transmission according to the separation requirement for the uplink transmission and the downlink reception of the terminal includes:
determining whether the terminal supports the simultaneous downlink reception and uplink transmission according to an UL BWP and a DL BWP monitored by the terminal on the operating band and the separation requirement for the uplink transmission and the downlink reception.

One band may be configured with one or more BWPs, the terminal may currently only be able to monitor some BWPs, and it is determined whether the terminal can currently support the simultaneous uplink transmission and downlink reception. If the terminal detects the UL BWP and the DL BWP, it means that the current bandwidth of the terminal can cover the uplink and downlink BWPs. In this case, it can be determined whether the terminal performs the downlink reception and the uplink transmission on the currently monitored BWP at the same time according to the separation requirement for the uplink transmission and the downlink reception corresponding to the operating band of the terminal.

The terminal may determine the BWP it is currently monitoring by monitoring the reference signal. If the terminal can successfully monitor a certain BWP, this BWP may be used as an operating BWP of the terminal or may be called an active BWP. The terminal may perform the uplink transmission and the downlink reception on the active BWP.

After the terminal monitors the corresponding BWP, it can notify the network device, so that the network device will know which BWP the terminal monitors. On the one hand, after receiving this notification, the network device can schedule the BWP in which the terminal operates. On the other hand, after receiving this notification, the network device can also determine whether the terminal currently supports the simultaneous uplink transmission and downlink reception based on the BWP monitored by the terminal and the separation requirement for the uplink transmission and the downlink reception, and further determine the FDD mode in which the terminal operates.

For example, the terminal may carry a flag bit and a BWP number in the notification. The flag bit may include one or more bits to indicate whether the monitored BWP is a UL BWP or a DL BWP. Further, the BWP number may indicate a number of the monitored UL BWP and/or a number of the monitored DL BWP.

In some embodiments, determining whether the terminal supports the simultaneous downlink reception and uplink transmission according to the UL BWP and the DL BWP monitored by the terminal on the operating band and the separation requirement for the uplink transmission and the downlink reception includes at least one of:
determining whether a frequency difference between a center frequency of the DL BWP and a center frequency of the UL BWP monitored by the terminal on the operating band meets the separation requirement for the uplink transmission and the downlink reception;
determining whether a frequency difference between a lowest frequency of the DL BWP and a highest frequency of the UL BWP monitored by the terminal on the operating band meets the separation requirement for the uplink transmission and the downlink reception; or
determining whether a frequency difference between a lowest frequency of the UL BWP and a highest frequency of the DL BWP monitored by the terminal on the operating band meets the separation requirement for the uplink transmission and the downlink reception.

The terminal detects positions of center frequencys, lowest frequencys, highest frequencys, etc. of the DL BWP and the UL BWP on the operating band, as shown in FIG. 5, FIG. 7 and FIG. 9, which will not be repeated here.

In some embodiments, determining whether the frequency difference between the lowest frequency of the DL BWP and the highest frequency of the UL BWP monitored by the terminal on the operating band meets the separation requirement for the uplink transmission and the downlink reception includes:
determining whether the frequency difference between the lowest frequency of the DL BWP and the highest frequency of the UL BWP detected by the terminal meets a separation requirement of a first threshold.

For example, for a case where an uplink channel bandwidth of the terminal is equal to a downlink channel bandwidth of the terminal, the first threshold may be equal to Fs-BW, where Fs may be a separation bandwidth value of the uplink transmission and the downlink reception on the operating band of the terminal, and BW may be an uplink channel bandwidth or a downlink channel bandwidth supported by the terminal.

For another example, for a case where the uplink channel bandwidth of the terminal is not equal to the downlink channel bandwidth of the terminal, the first threshold may be equal to Fs−0.5*uplink channel bandwidth−0.5*downlink channel bandwidth.

This is just an example of the first threshold, and a specific implementation is not limited to this example.

In some embodiments, determining whether the frequency difference between the lowest frequency of the UL BWP and the highest frequency of the DL BWP monitored by the terminal on the operating band meets the separation requirement for the uplink transmission and the downlink reception includes:
determining whether the frequency difference between the lowest frequency of the UL BWP and the highest frequency of the DL BWP monitored by the terminal meets a separation requirement of a second threshold.

When the uplink channel bandwidth supported by the terminal is equal to the downlink channel bandwidth supported by the terminal, the second threshold may be equal to Fs+BW, where Fs may be a separation bandwidth value of the uplink transmission and the downlink reception on the operating band of the terminal, and BW may be an uplink channel bandwidth or a downlink channel bandwidth supported by the terminal.

When the uplink channel bandwidth supported by the terminal is not equal to the downlink channel bandwidth supported by the terminal, the second threshold may be equal to Fs+0.5*uplink channel bandwidth+0.5*downlink channel bandwidth.

It should be noted that the above is merely an example of the second threshold, and the specific implementation is not limited to the above example.

In embodiments of the present disclosure, if the frequency difference between the highest frequency of the DL BWP and the lowest frequency of the UL BWP detected by the terminal is less than the second threshold, it can be considered that: the terminal currently supports the simultaneous uplink transmission and downlink reception; otherwise, it can be considered that the terminal currently does not support the simultaneous uplink transmission and downlink reception.

In some embodiments, S1220 may include:
when the terminal supports the simultaneous downlink reception and uplink transmission, determining that the terminal operates in a full-duplex FDD mode; and
when the terminal does not support the simultaneous downlink reception and uplink transmission, determining that the terminal operates in a half-duplex FDD mode.

Alternatively, in a specific implementation process, even if the terminal currently supports the simultaneous uplink transmission and downlink reception, the terminal may be configured to operate in the half-duplex FDD mode. For example, the terminal may be configured in the half-duplex FDD mode according to factors such as the service requirement of the terminal and/or the network load rate.

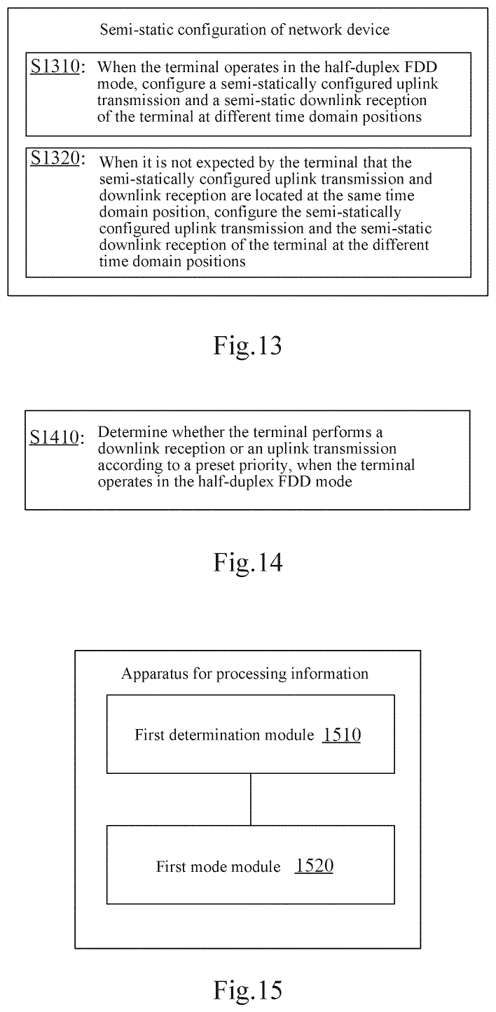

As shown in FIG. 13, embodiments of the present disclosure provide a method for processing information, which is performed by a network device. The method includes:
in S1310, when the terminal operates in the half-duplex FDD mode, semi-statically configured uplink transmission and downlink reception of the terminal are configured at different time domain positions; and
in S1320, when the terminal does not expect the semi-statically configured uplink transmission and downlink reception to be located at the same time domain position, the semi-statically configured uplink transmission and the semi-static downlink reception of the terminal are configured at the different time domain positions.

This embodiment can be implemented alone or in combination with any of the above-mentioned embodiments of the method for processing the information performed by the network device, for example, in combination with the method for processing the information shown in FIG. 12.

For example, when the terminal operates in the half-duplex FDD mode, or the base station determines that the terminal does not expect the semi-statically configured uplink transmission and downlink reception to be located at the same time domain position, or the terminal informs the base station that the semi-statically configured uplink transmission and downlink reception are located at the same time domain position, the uplink transmission and the downlink reception will be configured at different time domain positions when the semi-static configuration is performed for such terminal.

For the terminal not expecting the semi-statically configured uplink transmission and downlink reception to be located at the same time domain position, there are many situations, and two specific examples are provided below.

If the terminal determines to operate in the half-duplex FDD mode, it is determined that the terminal does not expect the semi-statically configured uplink transmission and downlink reception to be located at the same time domain position.

If the terminal supports the simultaneous uplink transmission and downlink reception, but the terminal determines, based on its own service characteristics and the like, that it does not expect the semi-statically configured uplink transmission and downlink reception to be located at the same time domain position.

As shown in FIG. 14, embodiments of the present disclosure provide a method for processing information, which is performed by a network device. The method includes:
in S1410, when the terminal operates in the half-duplex FDD mode, it is determined whether the terminal performs the downlink reception or the uplink transmission according to a preset priority.

This embodiment can be implemented alone or in combination with any of the above-mentioned embodiments of the method for processing the information performed by the network device, for example, in combination with the method for processing the information shown in FIG. 12 and/or FIG. 13.

For example, determining whether the terminal performs the downlink reception or the uplink transmission according to the preset priority includes at least one of:
determining the terminal to perform reception of a Synchronization Signal Block (SSB), when the uplink transmission of the terminal is in conflict with downlink reception of the SSB of the terminal;
determining the terminal to perform dynamically scheduled uplink transmission, when the dynamically scheduled uplink transmission of the terminal is in conflict with a semi-statically configured downlink reception of the terminal; or
determining the terminal to perform a dynamically scheduled downlink reception, when the dynamically scheduled downlink reception of the terminal is in conflict with a semi-statically configured uplink transmission of the terminal.

In some embodiments, if it is determined that the terminal performs the dynamically scheduled uplink transmission, the base station needs to receive the uplink transmission at a corresponding time-frequency resource position according to a dynamic scheduling instruction.

In some other embodiments, if it is determined that the terminal performs the dynamically scheduled downlink reception, the base station performs the downlink transmission at the corresponding time-frequency resource position according to a semi-static configuration.

For the normal terminal, since a channel bandwidth (BW) on the terminal side can be as large as the system bandwidth, the DL BWP and the UL BWP are switched independently in the FDD system, and the separation requirement for the uplink transmission and the downlink reception (Tx-Rx separation) can still be guaranteed.

However, for the RedCap terminal, the terminal bandwidth is reduced, and the switching of the BWP bandwidth will cause the switching of the transceiving center frequency. In some cases, the separation between transmitting and receiving frequencys can no longer meet the separation requirement for the uplink transmission and the downlink reception.

When the separation between the transmitting and receiving frequencys cannot meet the separation requirement for the uplink transmission and the downlink reception, a problem that the terminal cannot to transmit and receive at the same time will occur.

In order to ensure the flexibility of the BWP switching in the FDD system and also ensure the operating order of the transmission and reception of the terminal under the relaxed Tx-Rx separation requirement, embodiments of the present disclosure provide the following solution.

The terminal and/or the network device determine whether the terminal supports the simultaneous downlink reception and uplink transmission according to a preset condition.

In response to the terminal being unable to perform the simultaneous downlink reception and uplink transmission (transceiving for short), the terminal operates in the HD-FDD mode.

In response to the terminal being able to perform the simultaneous downlink reception and uplink transmission, the terminal operates in the FD-FDD mode.

The preset condition is determined based on a preset Tx-Rx separation requirement. For example, different operating bands have different separation requirements for the uplink transmission and the downlink reception.

The preset condition is that a center frequency of a target DL BWP of the terminal and a center frequency of a target UL BWP of the terminal meet the preset Tx-Rx separation requirement.

For example, the terminal operates in a certain band, and the preset Tx-Rx separation requirement is Fs MHz. Then the preset condition in this case is to determine that a center frequency separation between the active DL BWP and the active UL BWP of the terminal is Fs MHz.

A difference between the lowest frequency of the DL BWP and the highest frequency of the UL BWP of the terminal is greater than a certain threshold;
and/or,
a difference between the lowest frequency of the UL BWP and the highest frequency of the DL BWP of the terminal is less than a certain threshold.

For example, the preset Tx-Rx separation requirement for a certain band is Fs MHz, and whether the channel bandwidth of the terminal meets the preset condition is: determining whether a difference between the lowest frequency of the active DL BWP and the highest frequency of the active UL BWP of the terminal is greater than Fs−BW.

A difference between The highest frequency of the active DL BWP and the lowest frequency of the active UL BWP of the terminal is less than Fs+BW.

In response to determining that the terminal operates in the HD-FDD mode according to a preset condition.

The network device and/or the terminal performs the uplink transmission or the downlink reception of the terminal according to the transceiving priority of HD-FDD, and a processing rule for resolving the transceiving conflict based on the priority is as follows.

When the uplink transmission of the terminal conflicts with the downlink reception of the SSB of the terminal, the terminal abandons the uplink transmission and gives priority to the downlink reception of the SSB.

When the dynamically scheduled uplink/downlink transmission conflicts with the semi-statically configured downlink/uplink transmission, the dynamically scheduled uplink/downlink transmission takes precedence over the semi-statically configured downlink/uplink transmission.

The terminal does not expect the semi-statically configured uplink and downlink to occur at the same time domain position, so it can be determined by the scheduling configuration of the base station for the terminal.

The terminal determines whether the configuration of the BWP pair meets the Tx-Rx separation condition, and determines the duplex mode of the terminal according to the determination result.

As shown in FIG. 15, embodiments of the present disclosure provide an apparatus for processing information, including:
a first determination module 1510, configured to determine whether simultaneous downlink reception and uplink transmission are supported by a terminal; and
a first mode module 1520, configured to determine a Frequency Division Duplex (FDD) mode in which the terminal operates according to a result of determining whether the simultaneous downlink reception and uplink transmission are supported by the terminal.

In some embodiments, the apparatus for processing the information may be included in a terminal, which may be the aforementioned RedCap terminal, etc.

In some embodiments, the first determination module 1510 and the first mode module 1520 may be program modules, and the program module, when executed by a processor, can implement the above operations.

In some other embodiments, the first determination module 1510 and the first mode module 1520 may be modules in which software and hardware are combined. The modules in which software and hardware are combined may be various programmable arrays, which include but are not limited to: field programmable arrays and/or complex programmable arrays.

In some other embodiments, the first determination module 1510 and the first mode module 1520 may be pure hardware modules, which include but are not limited to application specific integrated circuits.

In some embodiments, the first determination module 1510 is configured to determine whether the simultaneous downlink reception and uplink transmission are supported by the terminal according to a separation requirement for an uplink transmission and a downlink reception on an operating band of the terminal.

In some embodiments, the first mode module 1520 is configured to determine whether the simultaneous downlink reception and uplink transmission are supported by the terminal according to a UL BWP and a DL BWP monitored by the terminal on the operating band and the separation requirement for the uplink transmission and the downlink reception.

In some embodiments, the first mode module 1520 is configured to perform at least one of:
determining whether a frequency difference between a center frequency of the DL BWP and a center frequency of the UL BWP monitored by the terminal on the operating band meets the separation requirement for the uplink transmission and the downlink reception;
determining whether a frequency difference between a lowest frequency of the DL BWP and a highest frequency of the UL BWP monitored by the terminal on the operating band meets the separation requirement for the uplink transmission and the downlink reception; or
determining whether a frequency difference between a lowest frequency of the UL BWP and a highest frequency of the DL BWP monitored by the terminal on the operating band meets the separation requirement for the uplink transmission and the downlink reception.

In some embodiments, the first determination module 1510 is configured to determine whether the frequency difference between the lowest frequency of the DL BWP and the highest frequency of the UL BWP detected by the terminal meets a separation requirement of a first threshold.

In some embodiments, the first determination module 1510 is configured to determine whether the frequency difference between the lowest frequency of the UL BWP and the highest frequency of the DL BWP monitored by the terminal meets a separation requirement of a second threshold.

In some embodiments, the first mode module 1520 is configured to determine that the terminal operates in a full-duplex FDD mode when the simultaneous downlink reception and uplink transmission are supported by the terminal; and determine that the terminal operates in a half-duplex FDD mode when the simultaneous downlink reception and uplink transmission are not supported by the terminal.

In some embodiments, the apparatus further includes:
a performing module, configured to perform a downlink reception or an uplink transmission according to a preset priority, when the terminal operates in the half-duplex FDD mode.

In some embodiments, the performing module is configured to perform at least one of:
performing reception of a Synchronization Signal Block (SSB) according to the preset priority, when the uplink transmission of the terminal is in conflict with a downlink reception of the SSB of the terminal;
performing a dynamically scheduled uplink transmission according to the preset priority, when the dynamically scheduled uplink transmission of the terminal is in conflict with a semi-statically configured downlink reception of the terminal; or
performing a dynamically scheduled downlink reception according to the preset priority, when the dynamically scheduled downlink reception of the terminal is in conflict with a semi-statically configured uplink transmission of the terminal.

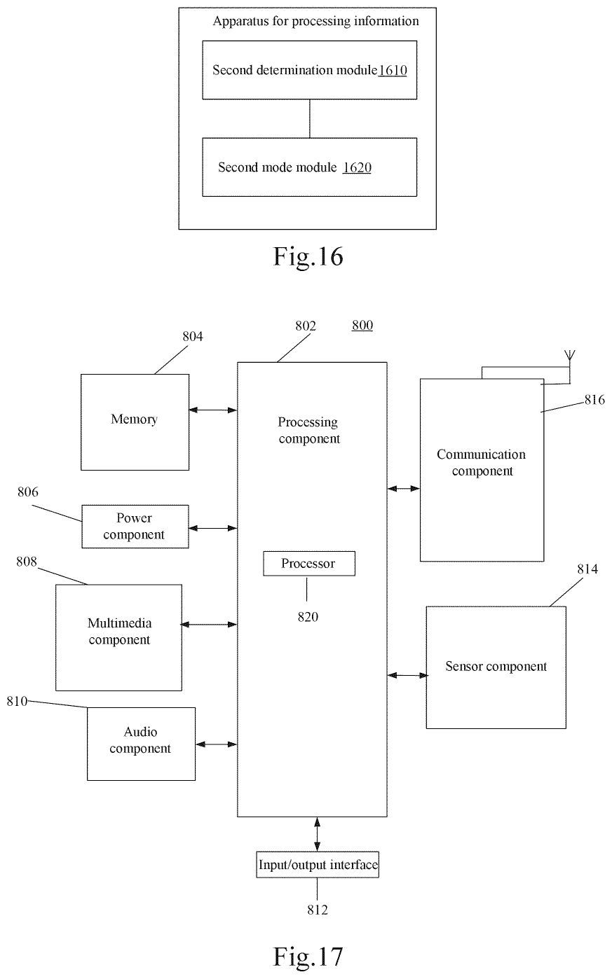

As shown in FIG. 16, embodiments of the present disclosure provide an apparatus for processing information, including:
a second determination module 1610, configured to determine whether simultaneous downlink reception and uplink transmission are supported by a terminal; and
a second mode module 1620, configured to determine a Frequency Division Duplex (FDD) mode in which the terminal operates according to a result of determining whether the simultaneous downlink reception and uplink transmission are supported by the terminal.

In some embodiments, the second determination module 1610 and the second mode module 1620 may be program modules, and the program module, when executed by a processor, can implement the above operations.

In other embodiments, the second determination module 1610 and the second mode module 1620 may be modules in which software and hardware are combined. The modules in which software and hardware are combined may be various programmable arrays, which include but are not limited to: field programmable arrays and/or complex programmable arrays.

In some other embodiments, the second determination module 1610 and the second mode module 1620 may be pure hardware modules, which include but are not limited to application specific integrated circuits.

In some embodiments, the second determination module 1610 is configured to determine whether the simultaneous downlink reception and uplink transmission are supported by the terminal according to a separation requirement for an uplink transmission and a downlink reception on an operating band of the terminal.

In some embodiments, the second determination module 1610 is configured to determine whether the simultaneous downlink reception and uplink transmission are supported by the terminal according to a UL BWP and a DL BWP monitored by the terminal on the operating band and the separation requirement for the uplink transmission and the downlink reception.

In some embodiments, the second determination module 1610 is configured to perform at least one of:
determining whether a frequency difference between a center frequency of the DL BWP and a center frequency of the UL BWP monitored by the terminal on the operating band meets the separation requirement for the uplink transmission and the downlink reception;
determining whether a frequency difference between a lowest frequency of the DL BWP and a highest frequency of the UL BWP monitored by the terminal on the operating band meets the separation requirement for the uplink transmission and the downlink reception; or
determining whether a frequency difference between a lowest frequency of the UL BWP and a highest frequency of the DL BWP monitored by the terminal on the operating band meets the separation requirement for the uplink transmission and the downlink reception.

In some embodiments, the second determination module 1610 is configured to perform at least one of:
determining whether the frequency difference between the lowest frequency of the DL BWP and the highest frequency of the UL BWP detected by the terminal meets a separation requirement of a first threshold.

In some embodiments, the second determination module 1610 is configured to determine whether the frequency difference between the lowest frequency of the UL BWP and the highest frequency of the DL BWP monitored by the terminal meets a separation requirement of a second threshold.

In some embodiments, the second mode module 1620 is configured to determine that the terminal operates in a full-duplex FDD mode when the simultaneous downlink reception and uplink transmission are supported by the terminal; and determine that the terminal operates in a half-duplex FDD mode when the simultaneous downlink reception and uplink transmission are not supported by the terminal.

In some embodiments, the apparatus further includes: a configuration module, configured to, when the terminal operates in the half-duplex FDD mode, configure a semi-statically configured uplink transmission and a semi-static downlink reception of the terminal at different time domain positions; and when it is not expected by the terminal that the semi-statically configured uplink transmission and downlink reception are located at the same time domain position, configure the semi-statically configured uplink transmission and the semi-static downlink reception of the terminal at the different time domain positions.

Embodiments of the present disclosure provide a communication device, including:
a memory configured to store executable instructions of a processor; and
a processor, connected to the memory,
the processor is configured to perform the method for processing the information provided by any of the aforementioned technical solutions.

The processor may include various types of storage mediums, which are non-transitory computer storage mediums that can continue to remember information stored thereon after the communication device loses power.

Here, the communication device includes a terminal or a network device, and the network device includes but is not limited to a base station.

The processor can be connected to the memory via a bus, etc., and is configured to read the executable program stored in the memory, for example, at least one of the methods shown in FIGS. 2, 3, 4, 6, 8 and 10 to 14.

FIG. 17 shows a block diagram of a terminal 800 according to an embodiment of the present disclosure. For example, the UE 800 may be a mobile phone, a computer, a digital broadcast terminal, a messaging device, a gaming console, a tablet device, a medical device, an exercise device, a personal digital assistant, etc.

Referring to FIG. 17, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal 800. Examples of such data include instructions for any applications or methods operated on the terminal 800, contact data, phonebook data, messages, pictures, video, etc. The memory 804 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 806 may include a power management system, one or more power sources, and any other components associated with the generation, management, and distribution of power in the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 808 includes a front camera and/or a rear camera. The front camera and the rear camera may receive an external multimedia datum while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide state assessments of various aspects of the terminal 800. For instance, the sensor component 814 may detect an open/closed state of the terminal 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal 800 and other devices. The terminal 800 may access a wireless network based on a communication standard, such as WiFi, 2G, or 3G, or a combination thereof. In an embodiment, the communication component 816 receives a broadcast signal or broadcast associated information from an external broadcast management system via a broadcast channel. In an embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the terminal 800 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for performing the above described methods.

In an embodiment of the present disclosure, there is further provided a non-transitory computer readable storage medium including instructions, such as the memory 804 including instructions, the above instructions may be executed by the processor 820 in the terminal 800 for performing the above-described methods. For example, the non-transitory computer-readable storage medium may be a ROM, a Random Access Memory (RAM), a CD-ROM, a magnetic tape, a floppy disc, an optical data storage device, and the like.

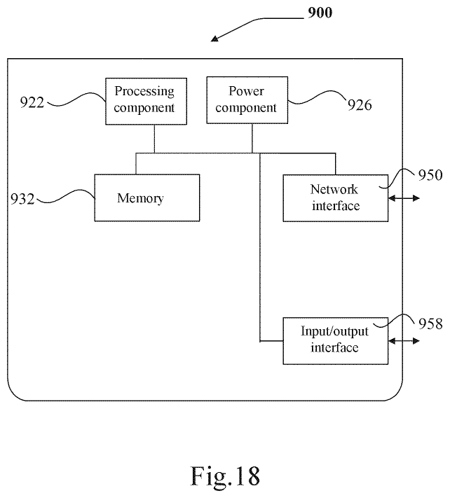

As shown in FIG. 18, an embodiment of the present disclosure provides a structure of an access device. For example, a communication device 900 may be provided as a network side device. The communication device may be a network device.

Referring to FIG. 18, the communication device 900 includes a processing component 922, which further includes one or more processors and a memory resource represented by a memory 932 for storing instructions executable by the processing component 922, such as an application program. The application program stored in the memory 932 may include one or more modules, each corresponding to a set of instructions. In addition, the processing component 922 is configured to execute the instructions to execute the aforementioned any method applied on the access network device, for example, at least one of the methods shown in FIGS. 2, 3, 4, 6, 8 and 10 to 14.

The communication device 900 may further include: a power component 926 configured to perform power management of the communication device 900, a wired or wireless network interface 950 configured to connect the communication device 900 to the network, and an input/output (I/O) interface 958. The communication device 900 may operate an operating system stored in the memory 932, such as Windows Server™, Mac OS X™, Unix™, Linux™, FreeBSD™, or the like.

Other implementations of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for processing information, performed by a terminal, and comprising:
determining whether simultaneous downlink reception and uplink transmission are supported by the terminal; and
determining a Frequency Division Duplex (FDD) mode in which the terminal operates according to a result of determining whether the simultaneous downlink reception and uplink transmission are supported by the terminal.

2. The method according to claim 1, wherein the determining whether the simultaneous downlink reception and uplink transmission are supported by the terminal comprises:
determining whether the simultaneous downlink reception and uplink transmission are supported by the terminal according to a separation requirement for an uplink transmission and a downlink reception on an operating band of the terminal.

3. The method according to claim 2, wherein the determining whether the simultaneous downlink reception and uplink transmission are supported by the terminal according to the separation requirement for the uplink transmission and the downlink reception on the operating band of the terminal comprises:
determining whether the simultaneous downlink reception and uplink transmission are supported by the terminal according to an uplink bandwidth part (UL BWP) and a downlink bandwidth part (DL BWP) monitored by the terminal on the operating band and the separation requirement for the uplink transmission and the downlink reception.

4. The method according to claim 3, wherein the determining whether the simultaneous downlink reception and uplink transmission are supported by the terminal according to the UL BWP and the DL BWP monitored by the terminal on the operating band and the separation requirement for the uplink transmission and the downlink reception comprises at least one of:
determining whether a frequency difference between a center frequency of the DL BWP and a center frequency of the UL BWP monitored by the terminal on the operating band meets the separation requirement for the uplink transmission and the downlink reception;
determining whether a frequency difference between a lowest frequency of the DL BWP and a highest frequency of the UL BWP monitored by the terminal on the operating band meets the separation requirement for the uplink transmission and the downlink reception; or
determining whether a frequency difference between a lowest frequency of the UL BWP and a highest frequency of the DL BWP monitored by the terminal on the operating band meets the separation requirement for the uplink transmission and the downlink reception.

5. The method according to claim 4, wherein the determining whether the frequency difference between the lowest frequency of the DL BWP and the highest frequency of the UL BWP monitored by the terminal on the operating band meets the separation requirement for the uplink transmission and the downlink reception comprises:
determining whether the frequency difference between the lowest frequency of the DL BWP and the highest frequency of the UL BWP monitored by the terminal meets a separation requirement of a first threshold.

6. The method according to claim 4, wherein the determining whether the frequency difference between the lowest frequency of the UL BWP and the highest frequency of the DL BWP monitored by the terminal on the operating band meets the separation requirement for the uplink transmission and the downlink reception comprises:
determining whether the frequency difference between the lowest frequency of the UL BWP and the highest frequency of the DL BWP monitored by the terminal meets a separation requirement of a second threshold.

7. The method according to claim 1, wherein the determining the FDD mode in which the terminal operates according to the result of determining whether the simultaneous downlink reception and uplink transmission are supported by the terminal comprises:
determining that the terminal operates in a full-duplex FDD mode when the simultaneous downlink reception and uplink transmission are supported by the terminal; and
determining that the terminal operates in a half-duplex FDD mode when the simultaneous downlink reception and uplink transmission are not supported by the terminal.

8. The method according to claim 1, wherein the method further comprises:
performing a downlink reception or an uplink transmission according to a preset priority, when the terminal operates in the half-duplex FDD mode.

9. The method according to claim 8, wherein the performing the downlink reception or the uplink transmission according to the preset priority, when the terminal operates in the half-duplex FDD mode comprises at least one of:
performing reception of a Synchronization Signal Block (SSB) according to the preset priority, when the uplink transmission of the terminal is in conflict with a downlink reception of the SSB of the terminal;
performing a dynamically scheduled uplink transmission according to the preset priority, when the dynamically scheduled uplink transmission of the terminal is in conflict with a semi-statically configured downlink reception of the terminal; or
performing a dynamically scheduled downlink reception according to the preset priority, when the dynamically scheduled downlink reception of the terminal is in conflict with a semi-statically configured uplink transmission of the terminal.

10. A method for processing information, performed by a network device, and comprising:
determining whether simultaneous downlink reception and uplink transmission are supported by a terminal; and
determining a Frequency Division Duplex (FDD) mode in which the terminal operates according to a result of determining whether the simultaneous downlink reception and uplink transmission are supported by the terminal.

11. The method according to claim 10, wherein the determining whether the simultaneous downlink reception and uplink transmission are supported by the terminal comprises:
determining whether the simultaneous downlink reception and uplink transmission are supported by the terminal according to a separation requirement for an uplink transmission and a downlink reception on an operating band of the terminal.

12. The method according to claim 10, wherein the determining whether the simultaneous downlink reception and uplink transmission are supported by the terminal according to the separation requirement for the uplink transmission and the downlink reception on the operating band of the terminal comprises:
determining whether the simultaneous downlink reception and uplink transmission are supported by the terminal according to an uplink bandwidth part (UL BWP) and a downlink bandwidth part (DL BWP) monitored by the terminal on the operating band and the separation requirement for the uplink transmission and the downlink reception.

13. The method according to claim 12, wherein the determining whether the simultaneous downlink reception and uplink transmission are supported by the terminal according to the UL BWP and the DL BWP monitored by the terminal on the operating band and the separation requirement for the uplink transmission and the downlink reception comprises at least one of:
determining whether a frequency difference between a center frequency of the DL BWP and a center frequency of the UL BWP monitored by the terminal on the operating band meets the separation requirement for the uplink transmission and the downlink reception;
determining whether a frequency difference between a lowest frequency of the DL BWP and a highest frequency of the UL BWP monitored by the terminal on the operating band meets the separation requirement for the uplink transmission and the downlink reception; or
determining whether a frequency difference between a lowest frequency of the UL BWP and a highest frequency of the DL BWP monitored by the terminal on the operating band meets the separation requirement for the uplink transmission and the downlink reception.

14. The method according to claim 13, wherein the determining whether the frequency difference between the lowest frequency of the DL BWP and the highest frequency of the UL BWP monitored by the terminal on the operating band meets the separation requirement for the uplink transmission and the downlink reception comprises:
determining whether the frequency difference between the lowest frequency of the DL BWP and the highest frequency of the UL BWP monitored by the terminal meets a separation requirement of a first threshold.

15. The method according to claim 13, wherein the determining whether the frequency difference between the lowest frequency of the UL BWP and the highest frequency of the DL BWP monitored by the terminal on the operating band meets the separation requirement for the uplink transmission and the downlink reception comprises:
determining whether the frequency difference between the lowest frequency of the UL BWP and the highest frequency of the DL BWP monitored by the terminal meets a separation requirement of a second threshold.

16. The method according to claim 10, wherein the determining the FDD mode in which the terminal operates according to the result of determining whether the simultaneous downlink reception and uplink transmission are supported by the terminal comprises:
determining that the terminal operates in a full-duplex FDD mode when the simultaneous downlink reception and uplink transmission are supported by the terminal; and
determining that the terminal operates in a half-duplex FDD mode when the simultaneous downlink reception and uplink transmission are not supported by the terminal.

17. The method according to claim 16, wherein the method further comprises:
when the terminal operates in the half-duplex FDD mode, configuring semi-statically configured uplink transmission and downlink reception of the terminal at different time domain positions; and
when it is not expected by the terminal that the semi-statically configured uplink transmission and downlink reception are located at the same time domain position, configuring the semi-statically configured uplink transmission and downlink reception of the terminal at the different time domain positions.

18.-34. (canceled)

35. A terminal, comprising:
a processor;
a transceiver; and
a memory storing a program executable by the processor,
wherein the processor is configured to:
determine whether simultaneous downlink reception and uplink transmission are supported by the terminal; and
determine a Frequency Division Duplex (FDD) mode in which the terminal operates according to a result of determining whether the simultaneous downlink reception and uplink transmission are supported by the terminal.

36. A non-transitory computer storage medium having an executable program stored thereon, wherein when the program is executed by a processor, the processor is caused to perform the method according to claim 1.

37. A non-transitory computer storage medium having an executable program stored thereon, wherein when the program is executed by a processor, the processor is caused to perform the method according to claim 10.
